(19) United States
(12) Patent Application Publication
(10) Pub. No.: US 2011/0053565 A1
(43) Pub. Date: Mar. 3, 2011

(54) SYSTEM AND METHOD FOR DELIVERING A MESSAGE DIGEST

(75) Inventors: Jonas Johansson, Saint Laurent (CA); Bernhard Meier, St. Lazare (CA)

(73) Assignee: TELEFONAKTIEBOLAGET LM ERICSSON (PUBL), Stockholm (SE)

(21) Appl. No.: 12/547,871

(22) Filed: Aug. 26, 2009

(51) Int. Cl. H04M 11/10; H04W 4/00

(52) U.S. Cl. 455/413; 455/466

(57) ABSTRACT

Systems and methods according to these exemplary embodiments provide for transmitting a digest message. This can occur by aggregating emails (and other messages) in a mobile network and transmitting a digest message to a mobile device. This then can improve communications efficiency by reducing message traffic as well as reducing costs for the users.

### TECHNICAL FIELD

The present invention relates generally to communications and in particular to methods, devices and systems involving mobile communication systems.

### BACKGROUND

During the past years, the interest in using mobile and landline/wireline computing devices in day-to-day communications has increased. Desktop computers, workstations, and other wireline computers currently allow users to communicate, for example, via e-mail, video conferencing, and instant messaging (IM). Mobile devices, for example, mobile telephones, handheld computers, personal digital assistants (PDAs), etc., also allow the users to communicate via e-mail, video conferencing, IM, and the like. Mobile telephones have conventionally served as voice communication devices, but through technological advancements they have recently proved to be effective devices for communicating data, graphics, etc. Wireless and landline technologies continue to merge into a more unified communication system, as user demand for seamless communications across different platforms increases.

With the advent of multimedia and 3G (and soon 4G) in the telecommunication area, it technically is no longer necessary to predicate the manner in which communications are performed on the type of media that is being communicated, i.e., 3G and 4G telecommunications are intended to be more media independent than previous generations of communications technology. Nonetheless, the introduction of new messaging functionality still, at least initially, tends to create a fragmentation of communication capabilities, as it is virtually impossible to upgrade all of the users in a system to the latest technology at the same time.

Most existing solutions for enabling messaging between end-users, i.e., from an originator of a message to a recipient of a message, are based on vertical architectures, wherein each messaging solution stands alone, i.e., each type of messaging typically has its own functionality for provisioning, service management, and other functions used to deliver messages of that type. FIG. 1 shows an exemplary communication system 100 having a vertical messaging architecture of a type which is commonly deployed by operators today. In FIG. 1, it will be seen that each messaging service or message type, e.g., Messaging over IP (MoIP), Multimedia Messaging Service (MMS), Instant Messaging (IM), Short Message Service (SMS), has associated therewith its own client, e.g., SMS client 102, MMS client 104 and Instant Messaging and Presence Services (IMPS) client 106, installed at the end user domain, and its own service center, e.g. MoIP center 108, multimedia messaging center (MMC) 110, SMS-C 112 and IMPS service center 114. Each of these service centers has their own message store, their own user directory, their own notification server and, sometimes, their own O&M system.

In one messaging scenario, end users may wish to receive messages, e.g., emails or email content through SMS or MMS messages, on their mobile phones. Currently, emails can be received by a mobile device as shown in the high level view of a communication system depicted by FIG. 2. Initially, emails 202 are received by a mobile communications system, typically by the MMC 204. The MMC 204 communicates with the HLR 206 over the SS7 interface to determine the status of the end user, e.g., to determine whether the end user is roaming. Additionally, the MMC 204 can be in communication with a node, e.g., database (DB) 210, which can contain other subscriber information such as, for example, services and subscriber preferences. Once the user's status is determined, the MMC 204 can push the email, typically in a text format using MMS or SMS, if the user is allowed/capable of receiving such text messages at his or her mobile device 208. However, when roaming, receiving emails in this way can be costly. Push email and other messaging methods that rely on internet connections, will typically either not use the internet when roaming, or will rely only on WiFi connections if not in the home network to reduce costs. When roaming the capability to receive emails is typically controlled as a binary option, i.e., receiving emails when roaming can either be turned on or turned off.

Accordingly, systems and methods for improving messaging options for mobile devices are desirable.

### SUMMARY

Exemplary embodiments relate to systems and methods for improving communications to a mobile device. According to exemplary embodiments, system and methods provide for transmitting or receiving a digest message. This can occur by aggregating emails (and other messages) in a mobile network sent toward a given user to generate a digest message and transmitting that digest message to a mobile device. Advantages according to exemplary embodiments include improved communications by potentially reducing message traffic, as well as reducing cost. However, it will be appreciated by those skilled in the art that such advantages are not to be construed as limitations of the present invention except to the extent that they are explicitly recited in one or more of the appended claims.

According to an exemplary embodiment a method for transmitting a digest message to a mobile device associated with a subscriber includes creating the digest message, wherein the digest message includes a list of a plurality of messages awaiting delivery to the subscriber, and transmitting the digest message to the mobile device associated with the subscriber.

According to another exemplary embodiment a method for receiving a digest message at a mobile device associated with a subscriber includes receiving the digest message, wherein the digest message includes a list of a plurality of messages awaiting delivery to the subscriber.

According to still another exemplary embodiment a communications node for transmitting a digest message to a mobile device associated with a subscriber includes a processor for creating the digest message, wherein the digest message includes a list of a plurality of messages awaiting delivery to the subscriber, and a communications interface for transmitting the digest message to the mobile device associated with the subscriber.

According to still another exemplary embodiment a mobile device for receiving a digest message associated with a subscriber includes a communications interface for receiving the digest message, wherein the digest message includes a list of a plurality of messages awaiting delivery to the subscriber.

### BRIEF DESCRIPTION OF THE DRAWINGS

The accompanying drawings illustrate exemplary embodiments, wherein:

FIG. 1 depicts an exemplary communication system having a vertical messaging architecture;

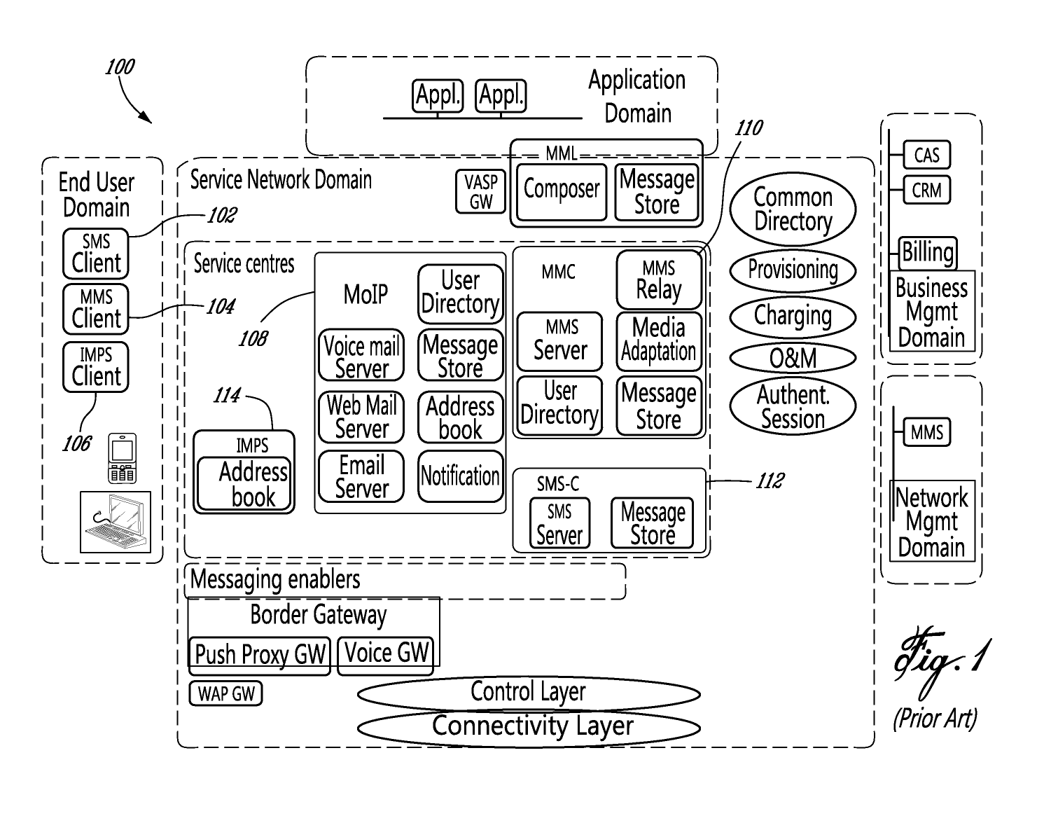

FIG. 2 shows an exemplary communication system for receiving and delivering emails to a mobile device;

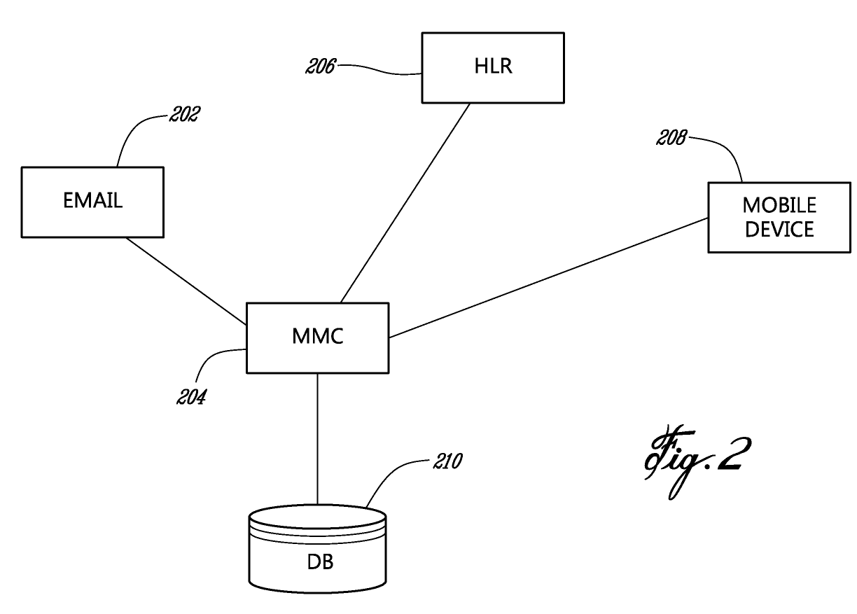

FIG. 3 illustrates a communication system for receiving and delivering emails to a mobile device according to exemplary embodiments;

FIG. 4 depicts a communication system for receiving and delivering emails to a mobile device according to another exemplary embodiment;

FIG. 5 shows a communication system for receiving and delivering emails to a mobile device using a pull system according to exemplary embodiments;

FIG. 6 shows a communication node according to exemplary embodiments;

FIG. 7 shows a method flowchart for transmitting a digest message to a mobile device according to exemplary embodiments; and

FIG. 8 shows a method flowchart for receiving a digest message by a mobile device according to exemplary embodiments.

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

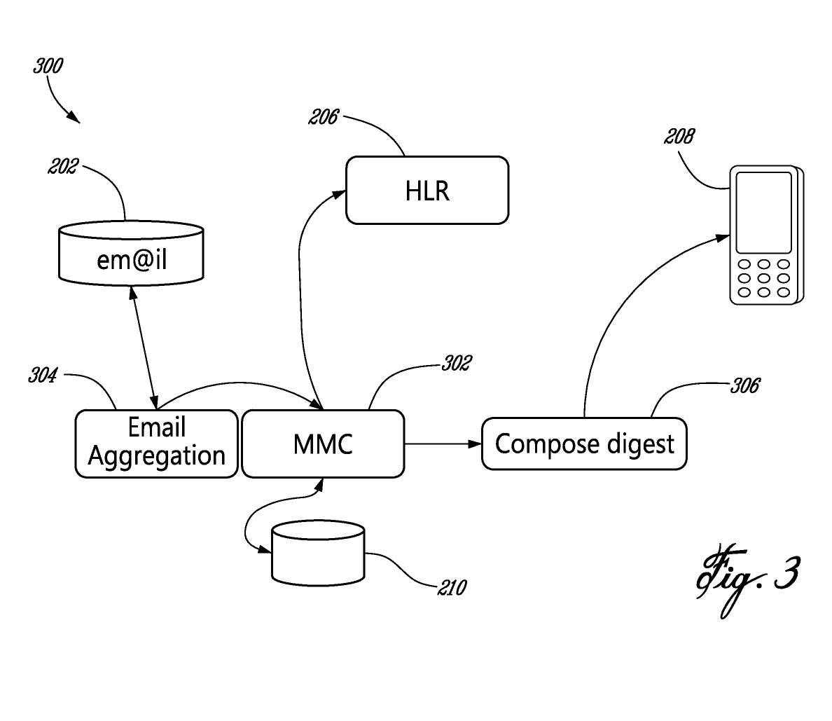

According to exemplary embodiments, systems and methods can improve messaging communications in communication networks. Initially, a framework for these exemplary embodiments will now be described with respect to FIG. 3. Initially, emails 202 (and/or other messages, e.g., voicemails) are received by the mobile communications system 300. These emails 202 can be aggregated by an e-mail aggregation function 304 which can be located within the multimedia messaging center (MMC) 302 or separately located at another communications node. A compose digest function 306 can be used to compose a digest message which includes emails (and/or other types of messages) available to an end user. A detailed example of digest message creation or composition is provided below. The compose digest function 306 can be located within the MMC 302 or separately located at another communications node, e.g., a messaging store node. Additionally, the compose digest function 306 can send messages to the mobile device 208 which is associated with a subscriber. For simplicity only these exemplary communication nodes and functions are shown in FIG. 3, however, those skilled in the art will realize that other communication nodes and functions can be used in the support of communications as needed, e.g., nodes of a radio access network (RAN) including base stations, eNodeBs or the like.

The usage of digest messages to aggregate message information for transmission to a user can, for example, be implemented selectively by the network based on some predetermined criteria, e.g., roaming status. Thus, according to some exemplary embodiments, using the above described exemplary communications framework shown in FIG. 3, the MMC 302 can act as a push e-mail server, detect when a user (also known as a subscriber) is roaming and compose a message digest to be delivered using, for example, Multimedia Messaging Service (MMS) or Short Message Service (SMS) to the user's mobile device 208. For example, an email aggregation function (or service) 304 checks for new messages on behalf of the subscriber using, e.g., Internet Message Access Protocol (IMAP), Post Office Protocol (POP) and the like. The MMC 302 is then notified that there are new message(s) for the subscriber. The MMC 302 then looks up the subscriber in the local database 210 and, in this exemplary case, learns that this subscriber has the message digest service enabled when roaming (as well as any other allowed services and preferences which are described below in more detail). The MMC 302 then communicates with the HLR 206 to determine the mobile status of the subscriber, and learns, in this case, that the subscriber is roaming, e.g., the mobile device 208 is not connected to the subscriber's home network but is instead connected to a different network. The MMC 302 communicates this information, e.g., the aggregated emails and subscriber information, to the compose digest function 306 which then composes and transmits a digest message to the subscriber, for example via SMS or MMS based on the subscriber's preference and/or other system considerations, e.g., the mobile device's 208 capabilities.

Although the foregoing example describes the triggering of the digest message composition and transmission based on roaming status, it will be appreciated that other alternatives exist. Digest messages could be created and transmitted regardless of a user's roaming status, i.e., both when a user is connected to his or her home network and when that user is connected to a visiting network. More generally, a digest on/off flag can be set in the network for each user to control when digest messages are to be created and transmitted and when, instead, messages are to be sent to the user as received by the network. The digest on/off flag may be set by the user or by the network.

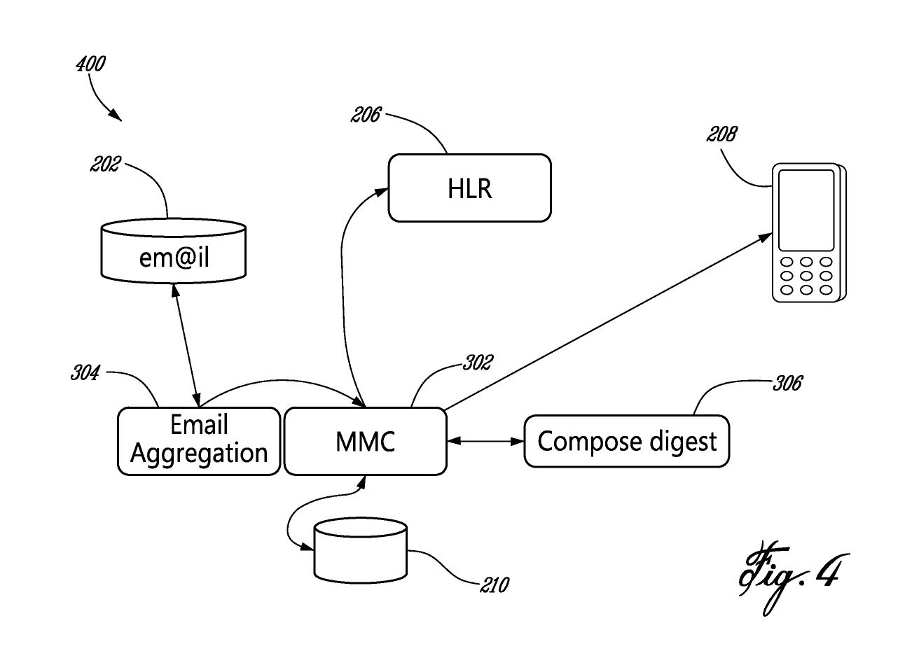

According to another exemplary embodiment, the MMC 302 can transmit the digest message to the mobile device 208 as shown in the communication system 400 of FIG. 4. FIG. 4 is similar to FIG. 3 and the exemplary communication method associated with FIG. 3 is similar to the one based upon FIG. 4. However, in this exemplary embodiment the MMC 302 transmits the email aggregation information to the compose digest function 306 which then composes the digest message and returns it to the MMC 302. The MMC 302 then transmits (pushes) the digest message, typically as either an SMS or MMS message, to the mobile device 208, e.g., via other nodes in a wireless communication system.

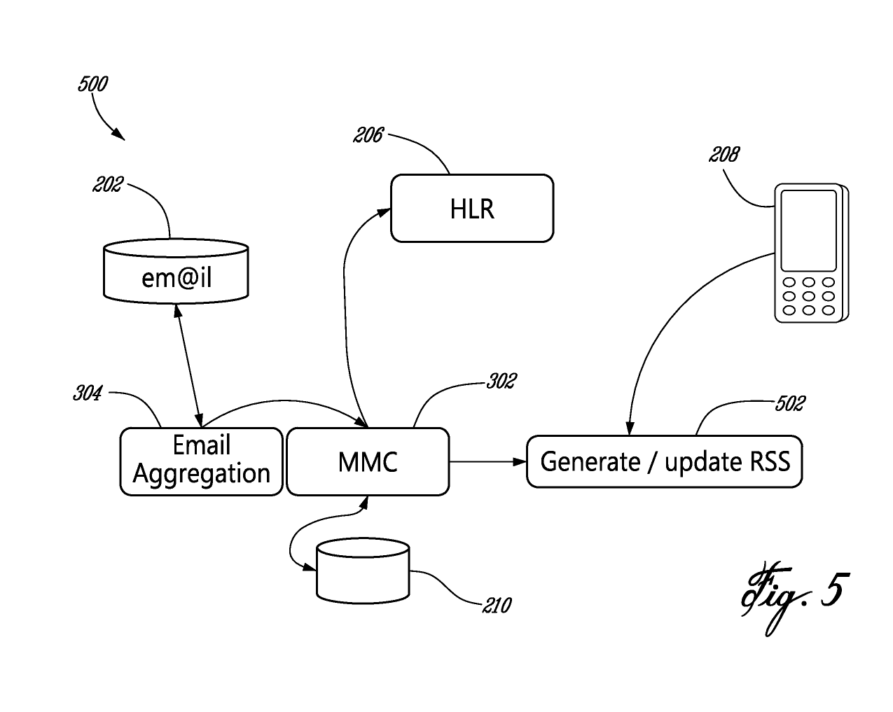

According to another exemplary embodiment a pull system can be used by the mobile device 208 for obtaining a digest message as shown in the communication system 500 of FIG. 5. Emails 202 (and/or other types of messages) are received by the communications network and an email aggregation function (or service) 304 checks for new messages on behalf of the subscriber using, e.g., Internet Message Access Protocol (IMAP), Post Office Protocol (POP) and the like. The MMC 302 is then notified that there are new message(s) for the subscriber. The MMC 302 then looks up the subscriber in the local database 210 and, in this exemplary case, learns that this subscriber has message digest service enabled, e.g., when roaming or otherwise.

The MMC 302 then creates/updates an RSS file regarding the message aggregation information for this mobile subscriber as shown by the generate/update Really Simple Syndication (RSS) function 502. This update can be in the form of eXtensible Markup Language (XML) text using Hypertext Transport Protocol HTTP transport. This allows the mobile device 208, or other Internet enabled device, to poll for this information as desired which can result in the deliverance of the digest message when requested by the mobile device 208.

According to exemplary embodiments, as described above, a digest message can be created or composed based upon information which is extracted from the received messages which are being aggregated. For example, a digest message can include links to each of the aggregated emails, as well as other useful information. Below is a purely illustrative example of a digest message according to an exemplary embodiment.

From: social@xmpp.org

Date: Jun. 6, 2009 1:00 PM

To: bill@ericsson.com

You have received:

1. Opera Unite: webserver in a browser (Dan Brickley)

2. Re: Opera Unite: webserver in a browser (Dave Cridland)

3. Re: Opera Unite: webserver in a browser (Alexis Richardson)
attachment: example1.pps

Select message subject link to fetch message/attachment, or log onto pixl8r to view them all.

In this example, the list of messages includes an executable link associated with each message. According to an alternative exemplary embodiment, not every message in the list of messages needs to have an executable link associated with it, i.e., at least one message in the list of messages will typically include an executable link. In this example, the compose digest function 306 or generate RSS function 502 has extracted message title, originator and attachment information from these messages which are awaiting delivery to a user to create the digest message. However, other formats, or templates, can be used to create a digest message. Additionally, more or less information can be provided in a digest message, e.g., attachment size, time of receipt, urgency, etc.

The above described exemplary embodiments associated with FIGS. 3, 4 and 5 have in some cases involved using roaming as a trigger for creating and then sending a digest message to the mobile device which includes the aggregated email list. However, as mentioned above, according to other exemplary embodiments the digest message can also be sent to non-roaming mobile devices. For example, instead of basing the initial decision to create and transmit a digest message based upon a roaming parameter, the mobile device 208 can notify the network of its desire to receive digest messages, e.g., digest on or digest off. For example, this feature can be useful in cases where the user has a type of mobile device 208, e.g., a smart phone, which includes a calendar function wherein when the user is in a meeting, the smart phone notifies the network to set the digest flag or function to off and upon completion of the meeting the mobile device 208 can set digest flag or function back to on, as desired. Additionally, various user preferences can be accepted into the system and used as a filter (or various filters) to determine which of the aggregated emails is put into the digest list as is described in more detail below.

According to exemplary embodiments, various subscriber preferences can be put in place to allow the system, e.g., logic at the MMC 302, to determine when to transmit digest messages and as well as what information should be used in the digest messages. For example, a periodicity of transmission could be used as a triggering mechanism, e.g., every two hours transmit a digest message. Alternatively, a quantity of aggregated emails could be used as a triggering mechanism, e.g., when five emails have been received by the system for a single user. Other potential parameters or flags for triggering the decision to create and transmit a digest message, as well as determining what messages or information should be in the digest, include, but are not limited to, sender, subject matter, urgency, time or any combination of these parameters of received messages which are awaiting delivery to a user. For example consider at 8:00 AM the system could send a digest including all messages since 5:00 PM of the previous day, or the system could transmit all urgent messages in a digest every four hours. Also, according to exemplary embodiments, the parameters used to allow the system to determine when to transmit a digest message, as well as what content to include, can be modifiable, in some cases, by the subscriber and/or the system. For example, the communications system may recognize that the mobile device 208 supports only SMS, therefore only templates for SMS will be considered for use.

According to exemplary embodiments described above, various formats can be used for the digest message, e.g., SMS and MMS. When using MMS as the format, the digest message can link to items hosted elsewhere, i.e., embedded objects are allowable by using Uniform Resource Locator(s) (URLs) in the digest message. For example, suppose that the system receives an email which includes a power point attachment. In the digest message, a link can be embedded which, when selected by the mobile device 208, will allow the mobile device to download the attachment from the host where it is located.

According to exemplary embodiments described above, an email aggregation function 304 collects emails for a subscriber. While emails and an email aggregation function 304 have been described, the exemplary embodiments described herein can be used for other types of messages and content. For example, voice mails, text messages and/or other types of messages for a subscriber could be aggregated and then put into a digest message. This could be performed in a single aggregation function and digest message, or in a multiple aggregation functions and digest messages as desired.

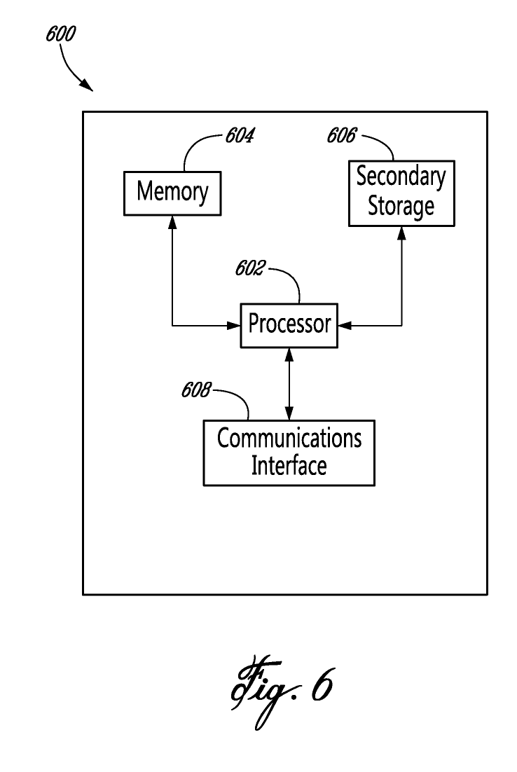

The exemplary embodiments described above provide methods and systems for sending a digest message to a mobile device, e.g., by a communications node 600 shown in FIG. 6 such as an MMC 302. Communications node 600 can contain a processor 602 (or multiple processor cores), memory 604, one or more secondary storage devices 606 and a communications interface 608. Communications node 600 is capable of aggregating emails and composing a digest message, as well as performing the other functions of an MMC 302. Therefore the communications node 600 can perform the functions of an MMC 302 as well as an email aggregation function 304 and a compose digest function 306 as a single node. Alternatively, if these functions are split between various messaging nodes the communications node 600 can perform those functions as needed, e.g., the communications node 600 can be a standalone node performing the function of an email aggregation function 304. Alternatively, communications node 600 can be a mobile device 208 which receives and interacts with digest messages as described above.

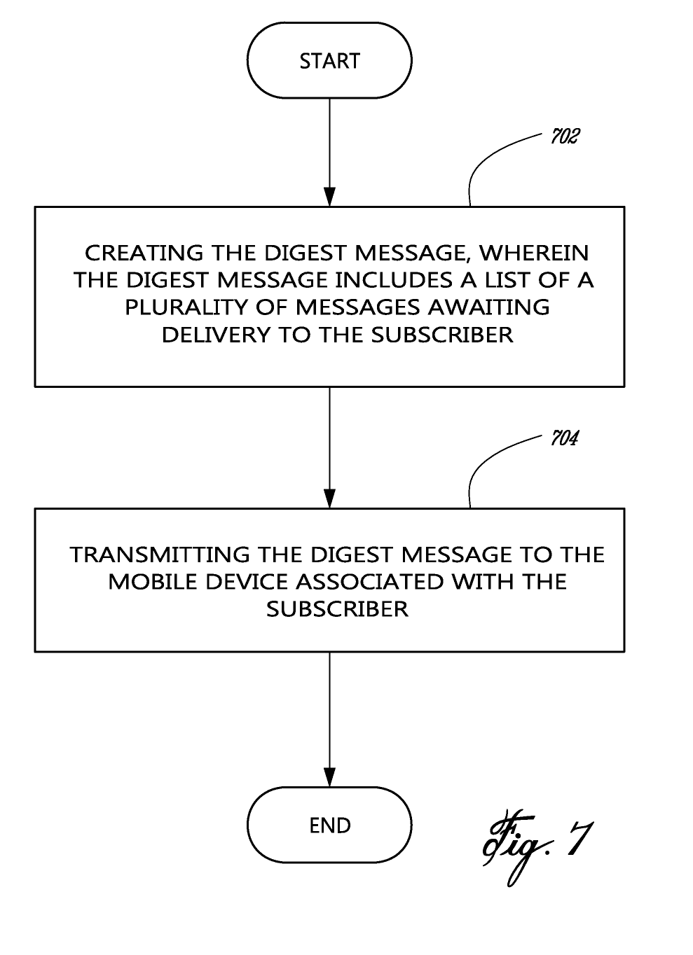

Utilizing the above-described exemplary systems according to exemplary embodiments, a method for transmitting a digest message is shown in the flowchart of FIG. 7. Initially a method for transmitting a digest message to a mobile device 208 associated with a subscriber includes: creating the digest message, wherein the digest message includes a list of a plurality of messages awaiting delivery to the subscriber in step 702; and transmitting the digest message to the mobile device associated with the subscriber in step 704.

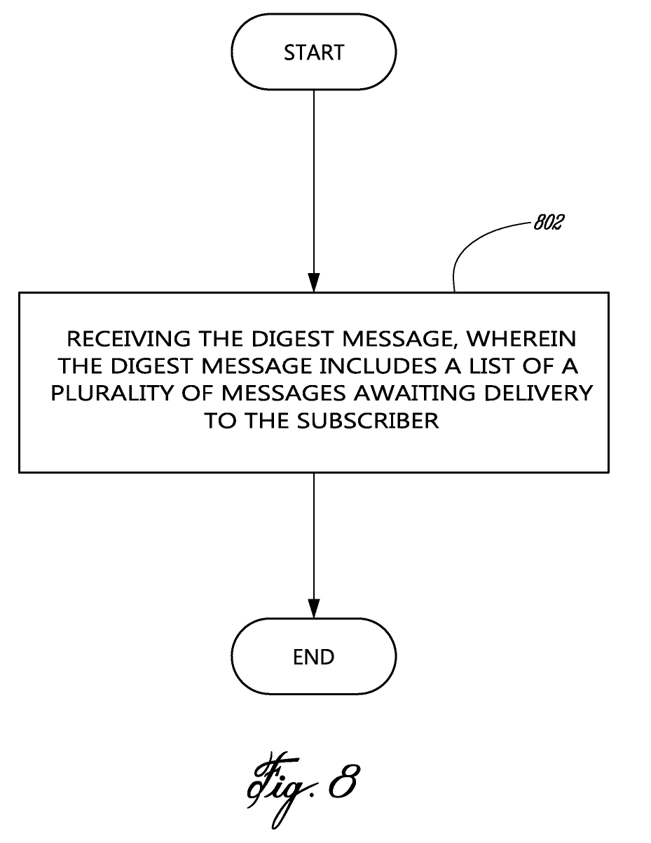

Utilizing the above-described exemplary systems according to exemplary embodiments, a method for receiving a digest message is shown in the flowchart of FIG. 8. Initially a method for receiving a digest message at a mobile device 208 associated with a subscriber includes: receiving the digest message, wherein the digest message includes a list of a plurality of messages awaiting delivery to the subscriber in step 802.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for transmitting a digest message to a mobile device associated with a subscriber comprising:
creating said digest message, wherein said digest message includes a list of a plurality of messages awaiting delivery to said subscriber; and
transmitting said digest message to said mobile device associated with said subscriber.

2. The method of claim 1, wherein said step of creating said digest message further comprises:
receiving said plurality of messages; and
aggregating information from said plurality of messages to create said digest message.

3. The method of claim 1, further comprising:
creating and transmitting said digest message only if said mobile device is roaming.

4. The method of claim 1, further comprising:
creating and transmitting said digest message only if a digest flag for said subscriber is set.

5. The method of claim 1, further comprising:
transmitting said digest message when at least one predetermined criteria is met.

6. The method of claim 5, wherein said at least one predetermined criteria is at least one of:
(a) a time period since a previous digest message was sent to said mobile device, (b) a number of messages which have been aggregated to generate said digest message, (c) a subject matter of one of said messages and (d) an originator of one of said messages.

7. The method of claim 1, wherein said list of messages represents at least one of emails and voice mails.

8. The method of claim 1, wherein said list of messages includes an executable link associated with at least one message, which when selected, retrieves said message.

9. The method of claim 1, further comprising:
receiving a message from said mobile device which requests transmission of said digest message.

10. A method for receiving a digest message at a mobile device associated with a subscriber comprising:
receiving said digest message, wherein said digest message includes a list of a plurality of messages awaiting delivery to said subscriber.

11. The method of claim 10, further comprising:
receiving said digest message only if said mobile device is roaming.

12. The method of claim 10, further comprising:
receiving said digest message only if a digest flag for said subscriber is set.

13. The method of claim 10, further comprising:
receiving said digest message when at least one predetermined criteria is met.

14. The method of claim 13, wherein said at least one predetermined criteria is at least one of: (a) a time period since a previous digest message was sent to said mobile device, (b) a number of messages which have been aggregated to generate said digest message, (c) a subject matter of one of said messages and (d) an originator of one of said messages.

15. The method of claim 10, wherein said list of messages includes an executable link associated with at least one message, which when selected, retrieves said message.

16. The method of claim 10, further comprising:
transmitting a message from said mobile device which requests transmission of said digest message.

17. A communications node for transmitting a digest message to a mobile device associated with a subscriber comprising:
a processor for creating said digest message, wherein said digest message includes a list of a plurality of messages awaiting delivery to said subscriber; and
a communications interface for transmitting said digest message to said mobile device associated with said subscriber.

18. The communications node of claim 17, wherein said processor aggregates information from said plurality of messages to generate said digest message and said communications interface receives said plurality of messages.

19. The communications node of claim 17, wherein said processor creates said digest message and said communications interface transmits said digest message only if said mobile device is roaming.

20. The communications node of claim 17, wherein said processor creates said digest message and said communications interface transmits said digest message only if a digest flag for said subscriber is set.

21. The method of claim 17, wherein said processor creates said digest message and said communications interface transmits said digest message when at least one predetermined criteria is met.

22. A mobile device for receiving a digest message associated with a subscriber comprising:
a communications interface for receiving said digest message, wherein said digest message includes a list of a plurality of messages awaiting deliver to said subscriber.

23. The mobile device of claim 22, wherein said communications interface receives said digest message only if said mobile device is roaming.

24. The mobile device of claim 22, wherein said communications interface receives said digest message only if a digest flag for said subscriber is set.

25. The mobile device of claim 22, wherein said communications interface receives said digest message when at least one predetermined criteria is met.
